(19) United States
(12) Patent Application Publication
(10) Pub. No.: US 2017/0243262 A1
(43) Pub. Date: Aug. 24, 2017

(54) APPARATUS AND METHOD FOR SELF-SERVICE PAYMENT

(71) Applicant: Intel Corporation, Santa Clara, CA (US)

(72) Inventors: Xiaoyong PAN, Shanghai (CN); Justin LIPMAN, Shanghai (CN)

(21) Appl. No.: 15/323,723

(22) PCT Filed: Aug. 8, 2014
(86) PCT No.: PCT/CN2014/083940

§ 371 Date: Jan. 3, 2017

(51) Int. Cl. G06Q 30/02; G06Q 20/32; G06Q 30/04; G06Q 20/10; G07B 15/06

(52) U.S. Cl. CPC G06Q 30/0283; G06Q 20/102; G07B 15/06; G06Q 30/04; G06Q 20/3224; G06Q 2240/00

(57) ABSTRACT

Embodiments of apparatuses and methods for self-service payment based on location and time information are described. In embodiments, a user device may include a token processing module to associate location or time information with a token received from a merchant, and a payment module to send a request to the merchant for determining a charge based on the token associated with the location or time information. In embodiments, a merchant device may include a token processing module to generate and send a token associated with a first location or a first time to a user device, and a billing module to determine a charge based on the token further associated with a second location or a second time, received from the user device. Other embodiments may be described and/or claimed.

### FIELD OF THE INVENTION

The present disclosure relates generally to the technical field of computing, and more particularly, to apparatuses and methods for self-service payment based on location or time information.

### BACKGROUND

The background description provided herein is for generally presenting the context of the disclosure. Unless otherwise indicated herein, the materials described in this section are not prior art to the claims in this application and are not admitted to be prior art or suggestions of the prior art by inclusion in this section.

Notwithstanding the advance of computing and related technologies, payment processes remain cumbersome in many situations. For example, the payment process for a driver to exit a parking garage or a toll station on a toll road can be inconvenient, involves significant waiting time, and causes congestion. As an example, when a driver enters into a garage or onto a toll highway, the driver may receive a ticket, which indicates the entry time or location. At the exit, the ticket may be returned back to calculate the duration of stay in the garage or the distance of travel on the toll road to determine fees due. The driver may then pay the fees due either using cash or a credit card at the exit. Frequently, this payment process takes a long time and causes a long line in a busy garage or on a toll road.

For the above example, an electronic toll collection (ETC) system may be implemented to partially reduce the delay in a busy garage or on a toll road by collecting tolls electronically. An ETC system may automatically classify a vehicle, automatically identify a vehicle, and automatically process a transaction. However, ETC systems generally require advance interaction between a user and the toll agency, such as for the user to establish an account with the toll agency so that the toll agency may electronically debit the account of this registered user without requiring the user to stop. It is a. major disadvantage for an ETC system to require all users to purchase a transponder as a start-up expense. Needless to say, it is either impractical or a waste for a user to purchase many transponders to be used in different ETC systems. Additionally, a user may prefer not to provide personal and financial information to an unfamiliar toll agency, for example, while traveling in a foreign country,

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a schematic diagram illustrating an example system configuration for location or time information based self-service payment, incorporating aspects of the present disclosure, in accordance with various embodiments.

FIG. 2 is a schematic diagram illustrating an example user device and merchant device for location or time information based self-service payment, incorporating aspects of the present disclosure, in accordance with various embodiments.

FIG. 3 is a flow diagram of an example process for location or time information based self-service payment, which may be practiced by an example user apparatus, incorporating aspects of the present disclosure, in accordance with various embodiments.

FIG. 4 is a flow diagram of another example process for location or time information based self-service payment, which may be practiced by an example merchant apparatus, incorporating aspects of the present disclosure, in accordance with various embodiments.

FIG. 5 illustrates an example computing device suitable for practicing the disclosed embodiments, in accordance with various embodiments.

FIG. 6 illustrates an article of manufacture having programming instructions, incorporating aspects of the present disclosure, in accordance with various embodiments.

### DETAILED DESCRIPTION

Embodiments of apparatuses and methods for self-service payment based on location and time information are described. In embodiments, a user device may include a token processing module to associate location or time information with a token received from a merchant, and a payment module to send a request to the merchant for determining a charge based on the token associated with the location or time information. In embodiments, a merchant device may include a token processing module to generate and send a token associated with a first location or a first time to a user device, and a billing module to determine a charge based on the token further associated with a second location or a second time, received from the user device. These and other aspects of the present disclosure will be more fully described below.

In the following detailed description, reference is made to the accompanying drawings, which form a part hereof, wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). Where the disclosure recites “a” or “a first” element or the equivalent thereof, such disclosure includes one or more such elements, neither requiring nor excluding two or more such elements. Further, ordinal indicators (e.g., first, second, or third) for identified elements are used to distinguish between the elements, and do not indicate or imply a required or limited number of such elements, nor do they indicate a particular position or order of such elements unless otherwise specifically stated.

Reference in the description to one embodiment or an embodiment means that a particular feature, structure, or characteristic described in connection with the embodiment is included in at least one embodiment of the invention. The description may use the phrases “in one embodiment,” “in another embodiment,” “in some embodiments,” “in embodiments,” “in various embodiments,” or the like, which may each refer to one or more of the same or different embodiments. Furthermore, the terms “comprising,” “including,” “having,” and the like, as used with respect to embodiments of the present disclosure, are synonymous.

In embodiments, the term “module” may refer to, be part of, or include an application specific integrated circuit (ASIC), an electronic circuit, a processor (shared, dedicated, or group), and/or memory (shared, dedicated, or group) that execute one or more software or firmware programs, a combinational logic circuit, and/or other suitable components that provide the described functionality. In embodiments, a module may be implemented in firmware, hardware, software, or any combination of firmware, hardware, and software.

In embodiments, for the purposes of the present disclosure, the term “recommendation” means any decision making, inference, or discovery, e.g., based at least in part on environmental data. For the purposes of the present disclosure, the phrase “context” or “contextual information” means any information that can be used to characterize the interaction between a user and a particular environmental setting.

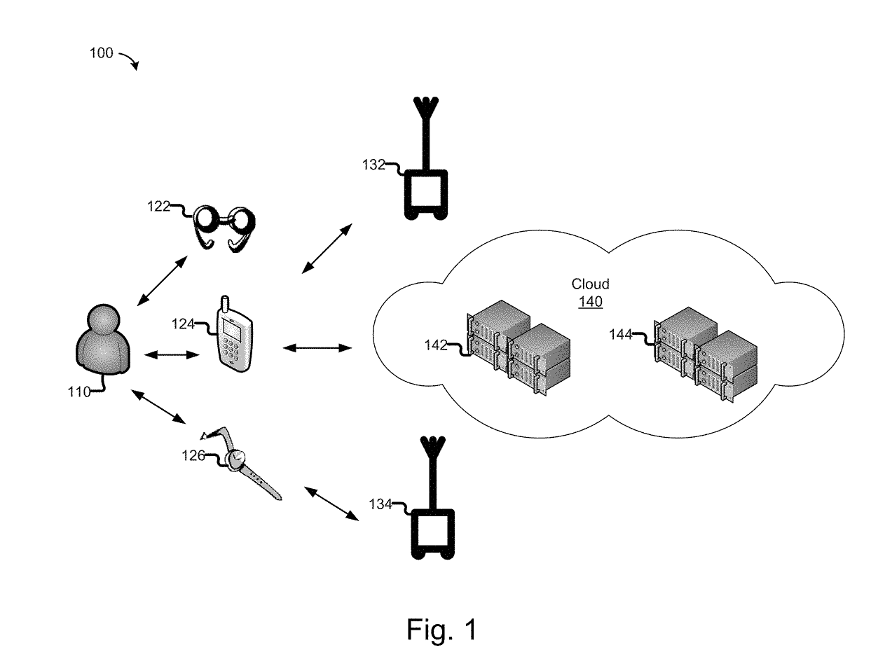

Referring now to FIG. 1, an example system configuration for location or time information based self-service payment, in accordance with various embodiments, is illustrated, System 100 may include various merchant devices and various user devices of one or more users, where some or all of these devices may have direct or indirect access via networking to service devices on a cloud. As illustrated in FIG. 1, various merchant devices may include, e.g., merchant devices 132 and 134. User devices may include, e.g., wearable devices 122 and 126, or mobile device 124. User 110 may be able to access one or more user devices, including mobile device 124 and wearable devices 122 and 126. in embodiments, mobile or wearable devices may wirelessly connect to merchant devise. Mobile or wearable devices may also wirelessly connect to service devices in computing cloud 140 (hereinafter, cloud 140), such as merchant server 142 and payment server 144. Similarly, merchant devices may also wirelessly connect to service devices in cloud 140. As will be described in more detail below, merchant devices, user devices, and service devices may be respectively incorporated with corresponding teachings of the present disclosure to enable a user for location or time information based self-service payment.

In embodiments, as described earlier, user devices in system 100 may include heterogeneous computing devices, such as, but not limited to, wearable devices 122 or 126, and mobile device 124, incorporated with the teachings of the present disclosure. Wearable device 122 or 126 may be wearable miniature computers, also known as body-borne computers. In embodiments, wearable device 122 or 126 may have a device body or form factor with shape, dimension, and materials configured for the device to be worn by a user. As an example, wearable device 122 may have a form factor configured to be worn on a head, such as in the arrangement of eyeglasses. As another example, wearable device 126 may have a form factor configured to be worn on a wrist, such as in the arrangement of watches. In embodiments, wearable device 122 or 126 may also be worn by the wearer under, with, or on top of clothing near other parts of a human body, such as the arm, leg, neck, foot, etc.

In embodiments, mobile device 124 may be a portable communication device, such as a smartphone or a tablet computer. While not illustrated, user devices in system 100 may also include a handheld computer, a laptop, a cellular phone, a pager, an audio and/or video player (e.g., an MP3 player, a DVD player, etc.), a gaming device, a video camera, a digital camera, a navigation device (e.g., a GPS device), a wireless peripheral (e.g., a headset, etc.), and/or other suitable user electronic devices, enhanced with the teachings of the present disclosure.

In embodiments, merchant device 132 or 134 may be mobile or stationary. As an example, merchant device 132 may be installed in a toll bridge as a stationary device. As another example, merchant device 134 may be a mobile device to be carried on various public transportation vehicles.

In some embodiments, merchant device 132. or 134 may be a ticket kiosk, which may offer the convenience of presenting a ticket with location or time information to a user. For example, the ticket may be associated with a parking garage, an airport, a toll road, an amusement park, a concert venue, a stadium, etc.

In some embodiments, merchant device 132 or 134 may be an interactive kiosk, which may feature specialized merchant hardware or software that provides a user access to merchant information and applications. For example, the interactive kiosk may provide a menu or map for a user to select a product or services.

In some embodiments, merchant device 132 or 134 may dynamically present location or time information to the user. As an example, merchant device 132 or 134 may embed location or time information in a ticket to users, such as in a barcode or quick response (QR) code. In some embodiments, such barcode or QR code may be simply presented on a display for users.

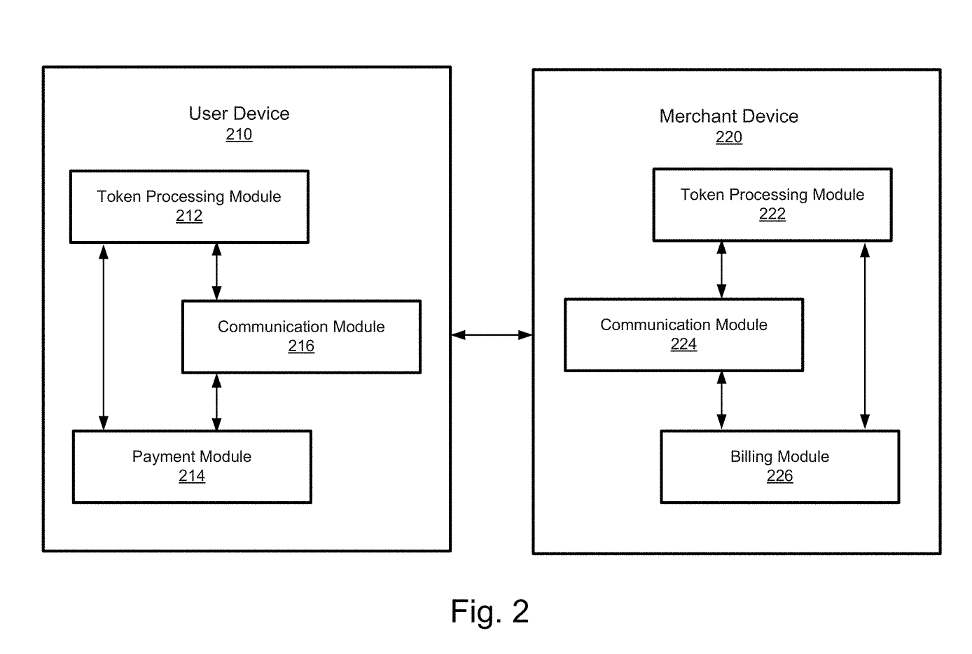

In embodiments, wearable devices 122 and 126, mobile device 124, merchant devices 132 or 134, or other suitable devices may be equipped with suitable modules, such as those illustrated in connection with FIG. 2, to enable location or time information based self-service payment. In some embodiments, these user or merchant devices may be configured to communicate with each other using dedicated short-range communications (DSRC), near field communication (NFC), or Bluetooth and Wi-Fi connections. Recognizing that the foregoing communication technologies were merely indicative of potential underlying communication technologies, which may be used between a user device and a merchant device, in other embodiments, different communication technologies may also be used. Therefore, a user device may receive or send location or time information from or to a merchant device, and vice versa.

In embodiments, user devices or merchant devices in system 100 may be configured to communicate with cloud 140, a computing infrastructure complex. Cloud 140 may support cloud computing, which generally refers to an adequately resourced computing model with resources, such as hardware, storage, management solutions, security solutions, business applications, etc., available as services via networking. Cloud 140 may generally offer its services as infrastructure as a service (IaaS), platform as a service PaaS), software as a service (SaaS), network as a service (NaaS), and communication as a service (CaaS). Moreover, cloud 140 may specifically offer services, based on one or more service types, such as IaaS, PaaS, SaaS, NaaS, or CaaS, supporting location or time information based self-service payment services. Furthermore, such services may be made available on demand and may be delivered economically.

In embodiments, cloud 140 may include one or more server devices, for example, merchant server 142 and/or payment server 144, incorporated with the teachings of the present disclosure, to cooperatively enable location or time information based self-service payment. In embodiments, merchant server 142 may be application servers, which may perform application related logic relating to location or time information based self-service payment. In some embodiments, merchant server 142 may be configured to manage the inventory of the merchant, manage shipping to consumers, manage the merchant-consumer relationship, and manage transactions, such as billing. In some embodiments, some components/functions of merchant server 142 may be distributed to various merchant devices, such as merchant device 132 or 134. Similarly, some components/functions of merchant device 132 or 134 may be consolidated back to merchant server 142 in other embodiments.

In embodiments, payment server 144 may be a third-party payment processor. In some embodiments, payment server 144 may be appointed by a merchant to handle financial transactions for the merchant. In some embodiments, payment server 144 may enable a user to make a payment to a merchant without having to first register or otherwise establish an account with the merchant. For example, payment server 144 may provide authorization and settlement services for a transaction between a user and a merchant by, for example, connecting with a financial institution linked with a user's credit card and a financial institution linked with a merchant.

In embodiments, payment server 144 may be configured to serve multiple user devices associated with a user, as well as multiple users. Payment server 144 may be configured to register or associate multiple user devices with a user, such as wearable device 122 and mobile device 124, using, for example, the user's email address, phone number, driver's license number, student identification number, passport number, biological information, or any other suitable credential. Therefore, regardless of which user device may be carried by the user, payment server 144 may still properly process payment transactions for the user. In embodiments, a user device, a merchant device, and payment server 144 may be separate and different entities.

In embodiments, cloud 140 may include one or more wireless and/or wired networks to operatively couple the user devices or merchant devices to those service devices. Cloud 140 may be accessed via public and/or private networks, such as, but not limited to, the Internet, a telephone network (e.g., public switched telephone network (PSTN)), a local area network (LAN), a wide area network (WAN), a cable network, an Ethernet network, and so forth. Wireless communication networks may include various combinations of wireless personal area networks (WPANs), wireless local area networks (WLANs), wireless metropolitan area networks (WMANs), and/or wireless wide area networks (WWANs). In embodiments, a user device or a merchant device may be coupled to these networks via a cellular network and/or a wireless connection.

As an example, user 110 may drive her car into a parking garage. User 110 may carry mobile device 124 with a self-service payment app installed on mobile device 124. At the entrance, merchant device 132, which may be a ticket machine in this case, may provide user 110 a ticket with a QR code encoded with the date and time when the ticket is printed along with other information of the parking garage. In some embodiments, merchant device 132 may issue a digital token containing similar or more information, rather than a physical ticket, to mobile device 124.

Sometime later, user 110 may plan to leave. User 110 may then scan the QR code with the self-service payment app installed on mobile device 124 or simply retrieve the digital token. The self-service payment app may then send a “check” request with a proposed exit time and the ticket/token ID to merchant server 142. In some embodiments, merchant server 142 may include the garage billing system. Merchant server 142 may determine a parking fee based in part on the entry time and the proposed exit time. Subsequently, merchant server 142 may return a digital token to mobile device 124, which includes the garage's information, the determined parking fee, acceptable payment options, etc.

At this point, user 110 may pay the garage directly, such as sending her credit card information directly to merchant server 142. Alternatively, user 110 may select one of her favorite third-party payment services, e.g., PayPal®. In this case, the self-service payment app may contact payment server 144 to complete the payment via the selected third-party payment service. Once the payment transaction is completed, merchant server 142 may update the status of the ticket to “Paid” in its system. In some embodiments, the status of the ticket may be propagated to merchant device 132 or 134.

When user 110 leaves the garage, she may return the ticket to merchant device 134. Merchant device 134 may already have the knowledge that the ticket has been paid in some embodiments. In other embodiments, merchant device 134 may obtain the current status of a ticket from merchant server 142. In either case, user 110 may exit the garage without further payment activities. In those embodiments, when user 110 utilizes payment server 144, user 110 may not need to reveal any personal or financial information to the merchant in this self-service payment system.

As another example, user 110 may drive onto a toll road with wearable device 122. In some embodiments, merchant device 132 may broadcast a digital token associated with the entry time and location information for the entry point. The digital token may be received by wearable device 122. In some embodiments, merchant device 132 may dynamically display a special diagram or icon on its display, such as a QR code encoded with the entry time and location information for the entry point. Wearable device 122 may read or scan the special diagram or icon.

Sometime later, user 110 may be ready to leave the toll road. Wearable device 122 may then, commanded by user 110 or automatically configured, send a payment request token to the toll authority of the toll road. The payment request token may include current time and/or current location information. The payment request token may be sent to a nearby merchant device 134 or a remote merchant server 142.

Merchant device 134 or merchant server 142 may determining a proper charge based on the time or location information in the payment request. Subsequently, merchant device 134 or merchant server 142 may send a billing token, with the determined charge, to wearable device 122. Wearable device 122 may pay or cause the charge to be paid using a pre-configured payment method of user 110. Upon receiving the payment, merchant device 134 or merchant server 142 may optionally send a receipt token to wearable device 122.

In embodiments, wearable device 122 may send at least one token, such as the original token received from merchant device 132, the payment request token, or the receipt token, to merchant device 134 at an exit point in the toll road. The toll authority may determine whether user 110 has paid proper fees for using the toll road based on the token received, and allow user 110 to exit the toll road if the proper fees have been paid at that moment.

Referring now to FIG. 2, an example implementation of user device 210 and merchant device 220 for location or time information based self-service payment, incorporating aspects of the present disclosure, in accordance with various embodiments, is illustrated. In embodiments, merchant device 220 may be a server device, such as merchant server 142 in FIG. 1. In embodiments, merchant device 220 may be a part of a distributed system with various components or subsystems distributed at various mobile or stationary devices, such as in merchant device 132 and merchant server 142. In embodiments, merchant device 220, in synergy with user device 210, may enable a self-service payment system based on location or time information.

Merchant device 220 may include token processing module 222. In embodiments, token processing module 222 may generate and send a token associated with a first location or a first time to a user device. In some embodiments, the token may be embedded in a physical ticket, such as in a barcode. In some embodiments, the token may be presented on a display of merchant device 220, such as in a QR code. In some embodiments, the token may include only a unique identifier without other information in which other information, including location or time information, may be stored in merchant device 220 or in other data storage without being transmitted to user device 210. In some embodiments, the token may include structured data in which location or time information may be presented with a markup language, such as extensible markup language (XML). In some embodiments, the token may be included in a message transmitted in one or more protocols understood by both merchant device 220 and user device 210, such as coded in extensible messaging and presence protocol (XMPP) or simple object access protocol (SOAP) and transmitted. over hypertext transfer protocol (HTTP) or simple mail transfer protocol (SMTP).

In some embodiments, the first location may be the physical location of merchant device 220 contacted by user device 210 in near distance. In some embodiments, the first location may be the identifier of a merchant device contacted by a user device, in which a contemporaneous location may be ascertained in a database via the identifier. In some embodiments, the first location may be identified in a request from user device 210, such as when a user particularly selects the first location. In some embodiments, the first time may be determined based on the system time in a toll system where merchant device 220 is deployed. In some embodiments, the first time may be identified in a request from user device 210, such as when a user particularly selects the first time.

User device 210 may include token processing module 212. In embodiments, token processing module 212 may be configured to read a token sent from or displayed on merchant device 220. As an example, token processing module 212 may include suitable hardware (e.g., a cameral and software to scan the barcode or QR code on a ticket or on a display of merchant device 220.

Further, in embodiments, token processing module 212 may associate location or time information, such as a second location or a second time, with the token received from merchant device 220. In some embodiments, token processing module 212 may associate a current location of user device 210 with the token. As an example, token processing module 212 may retrieve the current location of user device 210 from its own GPS module or from its cellular network. In some embodiments, token processing module 212 may associate an anticipated location for exiting a toll system with the token from merchant device 220. As an example, a user may select an exit point in the toll system in anticipating exiting from that exit point in the near future.

In embodiments, the first location and the second location may be related to user device 210 at different times. As an example, the first location is an entry point of a toll system, and the second location is an exit point of the toll system. User device 210 may enter the toll system from the entry point and exit the toll system from the exit point.

In some embodiments, token processing module 212 may associate current time with the token from merchant device 220. As an example, the system time of user device 200 may be used as the current time. As another example, the system time of a neutral reference, such as the time provided by a cellular network or a time authority, may be used as the current time. In some embodiments, token processing module 212 may associate an anticipated time for exiting a toll system with the token from merchant device 220. As an example, a user may expect to leave the toll system at a specific time therefore, token processing module 212 may associate that specific time with the token.

Token processing module 212 may be coupled to payment module 214. In embodiments, payment module 214 may send a request to the merchant for determining a charge based on the token associated with the location or time information. In embodiments, payment module 214 may send the request to billing module 226 in merchant device 220. In some embodiments, payment module 214 may send the request to a merchant device, such as merchant device 132 or 134. In some embodiments, payment module 214 may send the request to the merchant server, such as merchant server 142. In some embodiments, the token may include location or time information added by token processing modules 212 and 222, e.g., both the first and second location information. In other embodiments, the token in the request may only contain the latest location or time information added by token processing module 212 or payment module 214.

In merchant device 220, token processing module 222 may be coupled to billing module 226. In embodiments, billing module 226 may determine a charge based on the token sent by payment module 214. The token received from user device 210 may be further associated with the second location or the second time, in which the first and second locations may be different locations, and the second time may be subsequent to the first time, In embodiments, billing module 226 may have different billing structures for different merchants. As an example, for a toll road, the fee may be determined based on the distance between two locations. As another example, for a parking garage, the fee may be determined based on the time elapsed between two time points. For other merchants, the fee may be determined based on the combination of location information and time information. In other embodiments, the fee may be determined in part beyond the location or time information, such as based on a promotion, e.g., applying various discounts based on the environmental friendliness of the vehicle.

In embodiments, billing module 226 may verify location or time information associated with the token received from user device 210. As an example, billing module 226 may cross-check the location information against its own database. As another example, billing module 226 may verify the time information based on the system time of merchant device 220. In some embodiments, billing module 226 may use the system time of merchant device 220 in calculating the fees. In embodiments, ⁻billing module 226 may send user device 210 a checkout token with the determined charge.

Upon receiving the checkout token with the determined charge from merchant device 220, payment module 214 in user device 210 may initiate a payment to the merchant based on the checkout token. In some embodiments, payment module 214 may directly make a payment to the merchant, such as providing credit card information of the user to the merchant. In some embodiments, payment module 214 may make a payment to the merchant by using a third-party payment system in response to receiving the checkout token. In some embodiments, payment module 214 may use token processing module 212 to associate a payment confirmation to the checkout token upon completing the payment transaction, such as after receiving a confirmation message from the merchant or from the third-party payment system.

In embodiments, communication module 216 in user device 210 may utilize one or more wireless or wired networks to communicate with communication module 224 in merchant device 220. Those networks may include public and/or private networks, such as, but not limited to, LANs, WANs, or the Internet. In some embodiments, those networks may include wireless networks, like WP Ales, WLANs, WMANs, or WWANs. In some embodiments, those networks may include cellular networks; thus communications between communication modules 216 and 224 may be based at least in part on a cellular network.

In embodiments, user device 210 may exchange tokens with merchant device 220. As an example, communication module 216 may receive a token from the merchant and transmit a request to the merchant to determine the charge associated with another token. As another example, communication module 224 may transmit a checkout token or a payment confirmation token to user device 210.

In some embodiments, communications between communication module 216 and 224 may be based at least in part on dedicated short-range communications (DSRC), which include one-way or two-way short-range to medium-range wireless communication channels and a corresponding set of protocols and standards over physical layer, medium access and logical link control, application layer, etc.

In some embodiments, communications between communication modules 216 and 224 may be based at least in part on a radio-frequency identification standard (RFID). As an example, merchant device 220 or user device 210 may be equipped with a transponder to transfer data using radio-frequency electromagnetic fields. The transponder may contain electronically stored information, such as location or time information. The transponder may be powered by and read at short ranges via magnetic fields. In other embodiments, communications between communication modules 216 and 224 may be based at least in part on near field communication (NFC), optical communications, or other suitable communication technologies.

The embodiments and communications between communication modules 216 and 224 may be enabled without having to first register user device 210 with the merchant, e.g., only based on the token exchange between communication modules 216 and 224. In some embodiments, self-service payment may be facilitated by third-party payment services. Without revealing personal or financial information, a user may use user device 210 to complete payment transactions. Without receiving personal or financial information, a merchant may use merchant device 220 to complete billing transactions. Without additional upfront investment, a user may use his or her existing user devices to communicate with various merchants configured in such a self-service payment system.

In embodiments, user device 210 and merchant device 220 may be implemented differently as depicted in FIG. 2. As an example, token processing module 212 and payment module 214 may be implemented as an integrated module to process tokens and payments. As another example, token processing module 222 and billing module 226 may be implemented as an integrated module to process tokens and billings. In embodiments, some or all components of user device 210 or merchant device 220 may be distributed across any number of different devices or networks. As an example, various components in merchant device 220 may be distributed in multiple merchant devices or merchant servers.

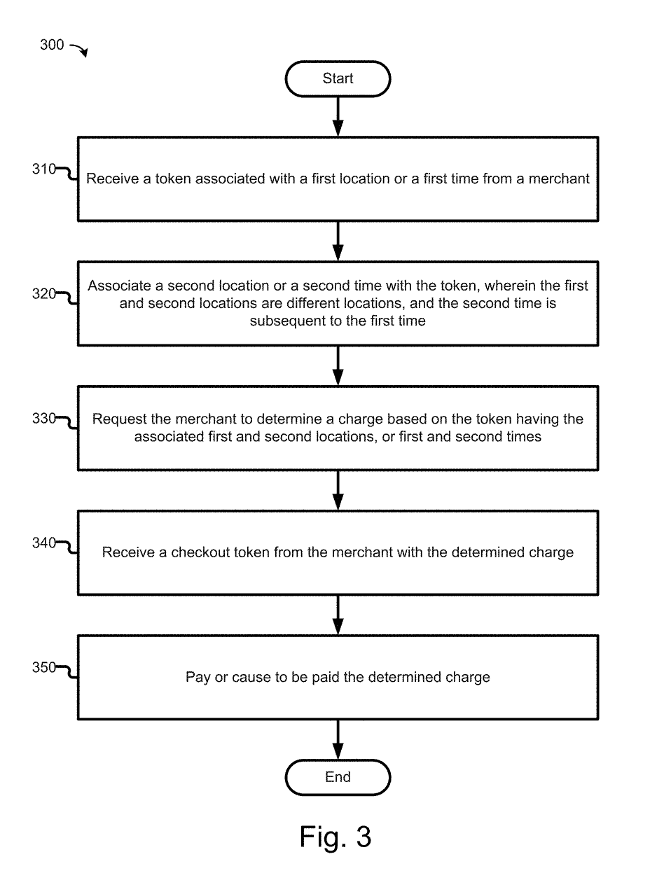

Referring now to FIG. 3, it is a flow diagram of an example process for location or time information based self-service payment, which may be practiced by an example user device in accordance with various embodiments. The process 300 may be performed by processing logic that comprises hardware (e.g., circuitry, dedicated logic, programmable logic, microcode, etc.), software (e.g., instructions run on a processing device to perform hardware simulation), or a combination thereof. The processing logic may be configured for location or time information based self-service payment. As such, process 300 may be performed by a computing device, e.g., device 210, to implement one or more embodiments of the present disclosure.

In embodiments, the process may begin at block 310, where a token associated with a first location or a first time from a merchant may be received, e.g., by token processing module 212 via communication module 216. As discussed in connection with FIG. 1 and FIG. 2, in embodiments, the token may be embodied in a paper ticket, a displayed icon, an electronic message, a datagram, or any suitable format for containing location or time information. In some embodiments, the token may be sent by the merchant automatically. In some embodiments, the token may be sent by the merchant upon a request from a user device.

Next, at block 320, a second location or a second time may be associated with the token, e.g., by token processing module 212. In embodiments, the first and second locations may be different locations, and the second time is subsequent to the first time.

Next, at block 330, a request may be sent to the merchant to determine a charge based on the token having the associated first and second locations, or first and second times, e.g., by payment module 214 via communication module 216. As an example, when the use plans to exit a toll system, a “check” request may be sent to the toll authority. In some embodiments, the request may include a part of the updated token. In some embodiments, the request may be trigged by the user's manual action. As an example, the user may scan the barcode and click a button on a user device. In some embodiments, the request may be trigged automatically, for example, when the user device approaches a point of sale location, e.g., a toll station.

Next, at block 340, a checkout token may be received from the merchant with the determined charge, e.g., by token processing module 212 via communication module 216. In some embodiments, the checkout token may be another print out ticket. In some embodiments, the checkout token may be simply displayed on a displaying device by the merchant. In some embodiments, the checkout token may be an electronic token sent to the user device via networking.

Next, at block 350, the determined charge may be paid or caused to be paid, e.g., by payment module 214 via communication module 216. In some embodiments, the determined charge may be paid directly from a user device to the merchant. In other embodiments, the determined charge may be paid using a third-party payment system, in which the user device, the merchant, and the third-party payment system may be different entities. In some embodiments, the determined charge may be paid by payment module 214 using a preconfigured payment method configured for a user, e.g., with the user's preferred third-party payment method.

In some embodiments, upon the completion of a payment transaction, a. payment confirmation token from the merchant or from the third-party payment system may be received by the user device. Further, the payment confirmation token may be presented by the user device to the merchant, e.g., at an exit of a toll road.

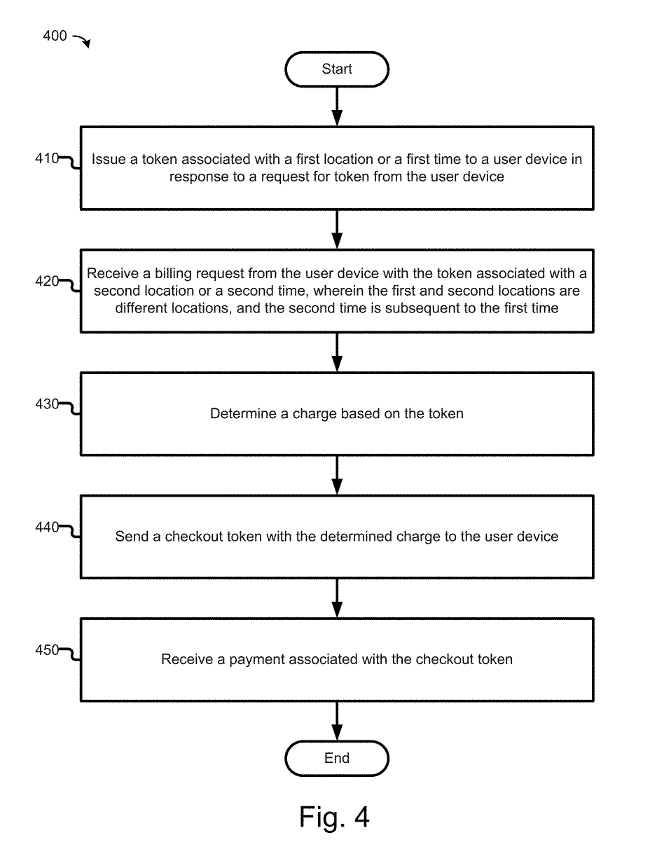

Referring now to FIG. 4, it is a flow diagram of an example process for location or time information-based self-service payment, which may be practiced by an example merchant apparatus in accordance with various embodiments. The process 400 may be performed by processing logic that comprises hardware e.g., circuitry, dedicated logic, programmable logic, microcode, etc.), software (e.g., instructions run on a processing device to perform hardware simulation), or a combination thereof. The processing logic may be configured for location or time information based self-service payment. As such, process 400 may be performed by a computing device, e.g., device 220, to implement one or more embodiments of the present disclosure. In embodiments, various blocks in FIG. 4 may be combined or arranged in any suitable order, e.g., according to the particular embodiment of a merchant device, to enable location or time information based self-service payment.

In embodiments, the process may begin at block 410, where a token associated with a first location or a first time may be issued to a user device, e.g., by token processing module 222. In embodiments, the token may be in a form of a physical card, printed barcode, QR code, or digital code sent to the user device through Wi-Fi, Bluetooth, Zigbee, etc. In some embodiments, the token may be issued automatically by a merchant device. In other embodiments, the token may be issued in response to a request for token from the user device. In embodiments, the merchant may have no prior knowledge of the user device or the user using the user device before receiving the request for token from the user device. In embodiments, the request for token from the user device may be anonymous without any user-specific information.

Next, at block 420, a payment request may be received from the user device with the token associated with a second location or a second time, e.g., by billing module 226. In embodiments, the first and second locations may be different locations, and the second time may be subsequent to the first time. In embodiments, location and time information may be verified by the merchant.

Next, at block 430, a charge may be determined based on the token, e.g., by billing module 226. In embodiments, the charge may be determined based on different billing structures for different merchants. In embodiments, the charge may be determined based on location or time information associated with the payment request received from a. user device. As an example, for a toll road, the fee may be determined based on the distance between two locations. As another example, for a parking garage, the fee may be determined based on the time elapsed between two time points. In some embodiments, the charge may be determined in part based on other rules, such as membership discount, coupons, etc.

Next, at block 440, a checkout token with the determined charge may be sent to the user device, e.g., by billing module 226 via communication module 224. In some embodiments, the checkout token may include other information, such as the payment methods acceptable to the merchant.

Next, at block 450, a payment associated with the checkout token may be received, e.g., by billing module 226 via communication module 224. In some embodiments, the payment may be received directly from a user device. In other embodiments, the payment may be received from a third-party payment system. In some embodiments, the merchant may update the status associated with all relevant tokens, such as change a token's status to “paid” in its system. In some embodiments, a payment confirmation token or a receipt may be sent to the user device, e.g., by billing module 226 via communication module 224 or by the third-party payment system.

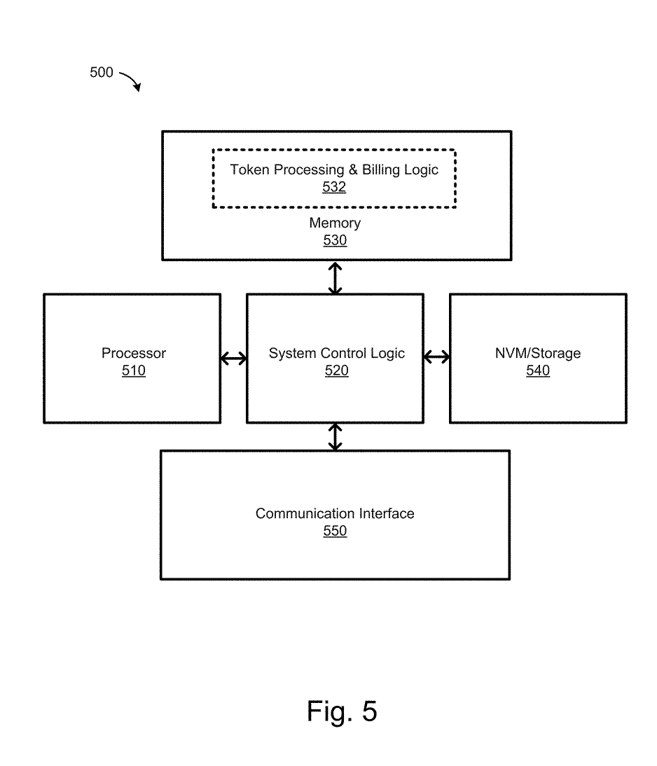

FIG. 5 illustrates an embodiment of a computing device 500 suitable for practicing embodiments of the present disclosure. Computing device 500 may be any computing device that is within a user's reach (e.g., a device that the user carries, wears, touches, gestures, etc.), in forms such as a smartphone, a tablet, a laptop, a wearable device, a server, etc. As illustrated, computing device 500 may include system control logic 520 coupled to processor 510, to system memory 530. to non-volatile memory (NVM)/storage 540, and to communication interface 550. In various embodiments, processor 510 may include one or more processor cores.

In embodiments, communication interface 550 may provide an interface for computing device 500 to communicate with the variety of user devices, the variety of merchant devices, or the variety of systems/services in the cloud as previously discussed in connection with FIG. 1. In embodiments, communication interface 550 may provide an interface for computing device 500 to communicate over one or more network(s) and/or with any other suitable device. Communication interface 550 may include any suitable hardware and/or firmware, such as a network adapter, one or more antennas, wireless interface(s), and so forth. In various embodiments, communication interface 550 may include an interface for computing device 500 to use radio-frequency identification (RBI)), near field communication (NFC), optical communications, or other similar technologies to communicate directly (e.g., without an intermediary) with another device. In various embodiments, communication interface 550 may interoperate with radio communications technologies such as, for example, Wideband Code Division Multiple Access (WCDMA), Global System for Mobile Communications (GSM), Long Term Evolution (LIE), Bluetooth®, Zigbee, and the like.

In some embodiments, system control logic 520 may include any suitable interface controllers to provide for any suitable interface to the processor 510 and/or to any suitable device or component in communication with system control logic 520. System control logic 520 may also interoperate with a display(not shown) for the display of information, such as to a user. In various embodiments, the display may include one of various display formats and forms, such as, for example, liquid-crystal displays, cathode-ray tube displays, e-ink displays, projection displays. In various embodiments, the display may include a touch screen.

In some embodiments, system control logic 520 may include one or more memory controller(s) (not shown) to provide an interface to system memory 530. System memory 530 may be used to load and store data and/or instructions, for example, for computing device 500. System memory 530 may include any suitable volatile memory, such as dynamic random access memory (DRAM), for example.

In some embodiments, system control logic 520 may include one or more input/output (I/O) controller(s) (not shown) to provide an interface to NVM/storage 540 and communication interface 550. NVM/storage 540 may be used to store data and/or instructions, for example. NVM/storage 540 may include any suitable non-volatile memory, such as flash memory, for example, and/or may include any suitable non-volatile storage device(s), such as one or more hard disk drive(s) (HDD), one or more solid-state drive(s), one or more compact disc (CD) drive(s), and/or one or more digital versatile disc (DVD) drive(s), for example. NVM/storage 540 may include a storage resource that is physically part of a device on which computing device 500 is installed or it may be accessible by, but not necessarily a part of, computing device 500. For example, NVM/storage 540 may be accessed by computing device 500 over a network via communication interface 550.

In embodiments, system memory 530, NVM/storage 540, and system control logic 520 may include, in particular, temporal and persistent copies of token processing & billing logic 532. Token processing & billing logic 532 may include instructions that, when executed by processor 510, result in computing device 500 providing location or time information based self-service payment, such as, but not limited to, processes 300 and 400. In embodiments, token processing & billing logic 532 may include instructions that, when executed by processor 510, result in computing device 500 performing various functions associated with token processing module 212, payment module 214, communication module 216, token processing module 222, billing module 226, and communication module 224, in connection with FIG. 2.

In some embodiments, processor 510 may be packaged together with system control logic 520 and/or token processing & billing logic 532. In some embodiments, at least one of the processor(s) 510 may be packaged together with system control logic 520 and/or token processing & billing logic 532 to form a System in Package (SiP). In some embodiments, processor 510 may be integrated on the same die with system control logic 520 and/or token processing & billing logic 532. In some embodiments, processor 510 may be integrated on the same die with system control logic 520 and/or token processing & billing logic 532 to form a System on Chip (SoC).

Depending on which modules of user device 210 or merchant device 220 in connection with FIG. 2 are hosted by computing device 500, the capabilities and/or performance characteristics of processor 510, system memory 530, and so forth, may vary. In various implementations, computing device 500 may be a smartphone, a tablet, a mobile computing device, a wearable computing device, a server, etc., enhanced with the teachings of the present disclosure.

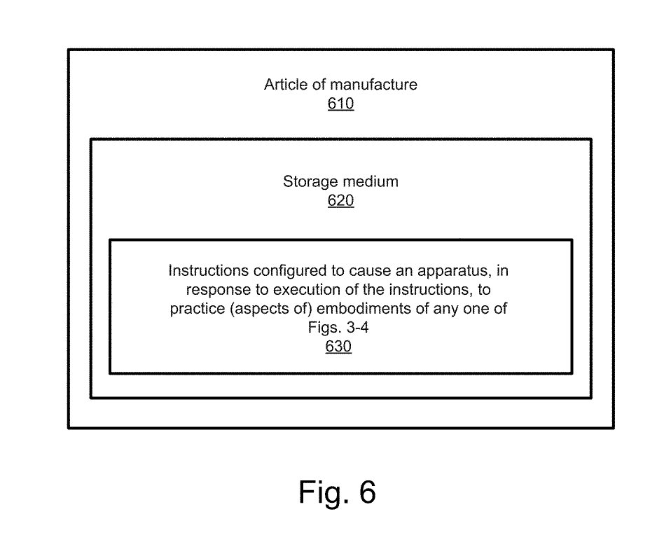

FIG. 6 illustrates an article of manufacture 610 having programming instructions, incorporating aspects of the present disclosure, in accordance with various embodiments. In various embodiments, an article of manufacture may be employed to implement various embodiments of the present disclosure. As shown, the article of manufacture 610 may include a computer-readable non-transitory storage medium 620 where instructions 630 are configured to practice embodiments of or aspects of embodiments of any one of the processes described herein. The storage medium 620 may represent a broad range of persistent storage media known in the art, including but not limited to flash memory, dynamic random access memory, static random access memory, an optical disk, a magnetic disk, etc. Instructions 630 may enable an apparatus, in response to their execution by the apparatus, to perform various operations described herein. As an example, storage medium 620 may include instructions 630 configured to cause an apparatus, e.g., user device 210, to practice some aspects of location or time information based self-service payment, as illustrated in process 300 of FIG. 3, in accordance with embodiments of the present disclosure. As another example, storage medium 620 may include instructions 630 configured to cause an apparatus, e.g., merchant device 220, to practice some aspects of location or time information based self-service payment, as illustrated in process 400 of FIG. 4, in accordance with embodiments of the present disclosure. In embodiments, computer-readable storage medium 620 may include one or more computer-readable non-transitory storage media. In other embodiments, computer-readable storage medium 620 may be transitory, such as signals, encoded with instructions 630.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

The following paragraphs describe examples of various embodiments.

Example 1 is an apparatus for self-service payment, which may include a token processing module to associate location or time information with a token received from a merchant, a payment module to send a request to the merchant for determining a charge based on the token associated with the location or time information, and a communication module coupled with the token processing module and the payment module to receive the token from the merchant and transmit the request to the merchant.

Example 2 may include the subject matter of Example 1, and may further specify that the communication module is to receive the token from the merchant based on a radio-frequency identification standard.

Example 3 may include the subject matter of Example 1 or 2, and may further specify that the communication module is to transmit the request to the merchant based at least in part on a cellular network.

Example 4 may include any subject matter of Examples 1-3, and may further specify that the token processing module is to associate a current location of the apparatus with the token.

Example 5 may include any subject matter of Examples 1-4, and may further specify that the token processing module is to associate an anticipated location for exiting a toll system with the token.

Example 6 may include any subject matter of Examples 1-5, and may further specify that the token processing module is to associate a current time with the token.

Example 7 may include any subject matter of Examples 1-6, and may further specify that the token processing module is to associate an anticipated time for exiting a toll system with the token.

Example 8 may include any subject matter of Examples 1-7, and may further specify that the location or time information comprises a plurality of locations or a plurality of times respectively.

Example 9 may include any subject matter of Examples 1-8, and may further specify that the location or time information comprises a distance between two locations or an elapsed time between two times.

Example 10 may include any subject matter of Examples 1-9, and may further specify that the communication module is to further receive the determined charge from the merchant, and the payment module is to further pay the determined charge via a third-party payment system in response to receiving the determined charge from the merchant.

Example 11 may include the subject matter of Example 10, and may further specify that the apparatus, the merchant, and the third-party payment system are different entities. Example 12 may include any subject matter of Examples 1-11, and may further specify that the token processing module is to associate a payment confirmation with the token.

Example 13 may include any subject matter of Examples 1-12, and may further specify that the communication module is to receive the token from the merchant and to transmit the request to the merchant, without having to first register with the merchant.

Example 14 is a method for self-service payment, which may include receiving, by a mobile computing device, a token associated with a first location or a first time from a merchant; associating, by the mobile computing device, a second location or a second time with the token, wherein the first and second locations are different locations, and the second time is subsequent to the first time; and requesting the merchant, by the mobile computing device, to determine a charge based on the token having the associated first and second locations, or first and second times.

Example 15 may include the subject matter of Example 14, and may further include receiving, by the mobile computing device, a checkout token from the merchant with the determined charge; and paying or causing to be paid, by the mobile computing device, the determined charge.

Example 16 may include the subject matter of Example 14 or 15, and may further include paying or causing to be paid, by the mobile computing device, the determined charge directly to the merchant.

Example 17 may include the subject matter of Example 14 or 15, and may further include paying, or causing to be paid, by the mobile computing device, the determined charge using a third-party payment system, wherein the mobile computing device, the merchant, and the third-party payment system are different entities.

Example 18 may include any subject matter of Examples 14-16, and may further include paying or causing to be paid, by the mobile computing device, the determined charge using a preconfigured payment method.

Example 19 may include any subject matter of Examples 14-18, and may further include receiving, by the mobile computing device, a payment confirmation token; and sending, by the mobile computing device, the payment confirmation token to an exit point of the merchant.

Example 20 is at least one storage medium, which may include a plurality of instructions configured to cause an apparatus, in response to execution of the instructions by the apparatus, to practice any subject matter of Examples 14-19.

Example 21 is an apparatus for self-service payment, which may include means for receiving a token associated with a first location or a first time from a merchant; means for associating a second location or a second time with the token, wherein the first and second locations are different, and the second time is subsequent to the first time; and means for requesting for the merchant to determine a charge based on the token.

Example 22 may include the subject matter of Example 21, and may further include means for receiving a checkout token from the merchant with the determined charge; and means for paying the determined charge using a third-party payment system, wherein the apparatus, the merchant, and the third-party payment system are different entities.

Example 23 is an apparatus for self-service payment, which may include a token processing module to generate and send a token associated with a first location or a first time to a user device; and a billing module, coupled to the token processing module, to determine a charge based on the token further associated with a second location or a second time, received from the user device, wherein the first and second locations are different locations, and the second time is subsequent to the first time.

Example 24 may include the subject matter of Example 23, and may further include a communication module to transmit the token to and from the user device.

Example 25 may include the subject matter of Example 24, and may further specify that the communication module is to communicate with the user device based on a radio-frequency identification standard.

Example 26 may include any subject matter of Examples 23-25, and may further specify that the first location and the second location are near the user device at different times.

Example 27 may include any subject matter of Examples 23-26, and may further specify that the first location is an entry point of a toll system, and the second location is an exit point of the toll system.

Example 28 may include any subject matter of Examples 23-27, and may further specify that the first time is determined by a system time of a toll system.

Example 29 may include any subject matter of Examples 23-28, and may further specify that the token processing module is to verify location or time information associated with the token received from the user device.

Example 30 may include any subject matter of Examples 23-29, and may further specify that the billing module is to send the user device a checkout token with the determined charge associated with the token.

Example 31 is a method for self-service payment, which may include issuing, by a computing system, a token associated with a first location or a first time to a user device in response to a request for token from the user device; receiving, by the computing system, a billing request from the user device with the token associated with a second location or a second time, wherein the first and second locations are different locations, and the second time is subsequent to the first time; and determining, by the computing system, a charge based on the token.

Example 32 may include the subject matter of Example 31, and may further include verifying, by the computing system, the token associated with the second location or the second time.

Example 33 may include the subject matter of Example 31 or 32, and may further include sending, by the computing system, a checkout token with the determined charge to the user device.

Example 34 may include any subject matter of Examples 31-33, and may further include receiving, by the computing system, a payment associated with the checkout token.

Example 35 may include the subject matter of Example 34, and may further include receiving the payment from a third-party payment system, wherein the computing system, the user device, and the third-party payment system are different entities.

Example 36 may include any subject matter of Examples 31-35, and may further include sending, by the computing system, a payment confirmation token to the user device.

Example 37 may include any subject matter of Examples 31-36, and may further specify that the computing system has no prior knowledge of the user device before receiving the request for token from the user device.

Example 38 is at least one storage medium, which may include a plurality of instructions configured to cause an apparatus, in response to execution of the instructions by the apparatus, to practice any subject matter of Examples 31-37.

Example 39 is an apparatus for self-service payment, which may include means for issuing a token associated with a first location or a first time to a user device in response to a request for token from the user device; means for receiving a billing request from the user device with the token further associated with a second location or a second time, wherein the first and second locations are different locations, and the second time is subsequent to the first time; and means for determining a charge based on the token.

Example 40 may include the subject matter of Example 39, and may further include means for sending a checkout token with the determined charge to the user device; and means for receiving a payment associated with the token from a third-party payment system, wherein the apparatus, the user device, and the third-party payment system are different entities, and wherein the apparatus has no prior knowledge of the user device before receiving the request for token from the user device.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

1. An apparatus, comprising:
a token processing module to associate location or time information with a token received from a merchant;
a payment module to send a request to the merchant for determining a charge based on the location or time information associated with the token; and
a communication module coupled with the token processing module and the payment module to receive the token from the merchant and transmit the request to the merchant.

2. The apparatus according to claim 1, wherein the communication module is to receive the token from the merchant based on a radio-frequency identification standard.

3. The apparatus according to claim 1, wherein the communication module is to transmit the request to the merchant based at least in part on a cellular network.

4. The apparatus according to claim 1, wherein the token processing module is to associate a current location of the apparatus or a current time with the token.

5. The apparatus according to claim 1, wherein the token processing module is to associate an anticipated location or an anticipated time for exiting a toll system with the token.

6. The apparatus according to claim 1, wherein the location or time information comprises a distance between two locations or an elapsed time between two times.

7. The apparatus according to claim 1, wherein the communication module is to further receive the determined charge from the merchant, and the payment module is to further pay the determined charge via a third-party payment system in response to receiving the determined charge from the merchant.

8. The apparatus according to claim 1, wherein the token processing module is to associate a payment confirmation with the token.

9. The apparatus according to claim 1, wherein the communication module is to receive the token from the merchant and to transmit the request to the merchant, without having to first register with the merchant.

10. A method, comprising:
receiving, by a mobile computing device, a token associated with a first location or a first time from a merchant;
associating, by the mobile computing device, a second location or a second time with the token, wherein the first and second locations are different locations, and the second time is subsequent to the first time; and
requesting the merchant, by the mobile computing device, to determine a charge based on the token having the associated first and second locations, or first and second times.

11. The method of claim 10, further comprising:
receiving, by the mobile computing device, a checkout token from the merchant with the determined charge; and
paying or causing to be paid, by the mobile computing device, the determined charge.

12. The method of claim 10, further comprising:
paying, or causing to be paid, by the mobile computing device, the determined charge using a third-party payment system, wherein the mobile computing device, the merchant, and the third-party payment system are different entities.

13. The method of claim 10, further comprising:
paying or causing to be paid, by the mobile computing device, the determined charge using a preconfigured payment method.

14. The method of claim 10, further comprising:
receiving, by the mobile computing device, a payment confirmation token; and
sending, by the mobile computing device, the payment confirmation token to an exit point of the merchant.

15. An apparatus, comprising:
a token processing module to generate and send a token associated with a first location or a first time to a user device; and
a billing module, coupled to the token processing module, to determine a charge based on the token further associated with a second location or a second time, received from the user device, wherein the first and second locations are different locations, and the second time is subsequent to the first time.

16. The apparatus according to claim 15, further comprising:
a communication module to transmit the token to and from the user device.

17. The apparatus according to claim 15, wherein the first location and the second location are near the user device at different times.

18. The apparatus according to claim 15, wherein the first location is an entry point of a toll system, and the second location is an exit point of the toll system.

19. The apparatus according to claim 15, wherein the first time is determined by a system time of a toll system.

20. The apparatus according to claim 15, wherein the token processing module is to verify location or time information associated with the token received from the user device.

21. The apparatus according to claim 15, wherein the billing module is to send the user device a checkout token with the determined charge associated with the token.

22. A method, comprising:
issuing, by a computing system, a token associated with a first location or a first time to a user device in response to a request for token from the user device;
receiving, by the computing system, a billing request from the user device with the token associated with a second location or a second time, wherein the first and second locations are different locations, and the second time is subsequent to the first time; and
determining, by the computing system, a charge based on the token.

23. The method of claim 22, further comprising:
verifying, by the computing system, the token associated with the second location or the second time.

24. The method of claim 22, further comprising:
sending, by the computing system, a checkout token with the determined charge to the user device; and
receiving a payment from a third-party payment system associated with the checkout token, wherein the computing system, the user device, and the third-party payment system are different entities.

25. The method of claim 22, wherein the computing system has no prior knowledge of the user device before receiving the request for token from the user device.
